(19) United States
(12) Patent Application Publication
(10) Pub. No.: US 2025/0266585 A1
(43) Pub. Date: Aug. 21, 2025

(54) HIGH-CAPACITY BATTERY CELL AND MANUFACTURING METHOD THEREOF

(71) Applicant: SK On Co., Ltd., Seoul (KR)

(72) Inventors: Taik Keun KIM, Daejeon (KR); Seon Ho KIM, Daejeon (KR); Tae Hun EOM, Daejeon (KR)

(21) Appl. No.: 19/052,291

(22) Filed: Feb. 13, 2025

(30) Foreign Application Priority Data
Feb. 15, 2024 (KR) 10-2024-0022010

(51) Int. Cl. H01M 50/536; H01M 50/54

(52) U.S. Cl. CPC H01M 50/536; H01M 50/54

(57) ABSTRACT

Proposed is a high-capacity battery cell, including a unit assembly in which a plurality of unit electrode assemblies are stacked. A plurality of individual tab portions of the plurality of unit electrode assemblies are integrally joined together and joined to an integrated tab portion at one or each of opposite ends of the unit assembly. By manufacturing one high-capacity battery cell by stacking and bonding a plurality of unit electrode assemblies, it is possible to implement a high-capacity battery cell of various specifications, thereby effectively expanding the degree of freedom in designing the thickness of a pouch-type battery cell.

### CROSS REFERENCE TO RELATED APPLICATION

The present application claims priority to Korean Patent Application No. 10-2024-0022010, filed Feb. 15, 2024, the entire contents of which is incorporated herein for all purposes by this reference.

### BACKGROUND OF THE INVENTION

### Field of the Invention

The present disclosure relates to a high-capacity battery cell and a manufacturing method thereof.

### Description of the Related Art

Recently, secondary batteries have attracted attention as a promising energy source as they have been widely used in various fields such as IT products, automobiles, and energy storage. Secondary batteries for IT products are required to have a long operable time, a small size, and a light weight, while secondary batteries for automobiles are required to have high power, durability, and safety so as to be free from risk of explosion. In the field of energy storage, secondary batteries are used to store excess electricity which is generated through wind power or solar energy generation and may not be required to have highly advanced features.

For secondary batteries, the demand for high-capacity batteries with high energy density is increasing day by day. To meet this, attempts have been made to increase the wetting property of an electrolyte. However, since these high-capacity batteries have a much larger size and thickness than conventional ones, various limitations due to the structure of conventional secondary batteries and various problems in their manufacturing methods are emerging.

The foregoing is intended merely to aid in the understanding of the background of the present disclosure, and is not intended to mean that the present disclosure falls within the purview of the related art that is already known to those skilled in the art.

### Documents of Related Art

(Patent document 1) Korean Patent Application Publication No. 10-2016-0015098

### SUMMARY OF THE INVENTION

Accordingly, the present disclosure has been made keeping in mind the above problems occurring in the related art, and one objective of the present disclosure is to provide a high-capacity battery cell having various specifications by stacking and using a plurality of unit electrode assemblies.

Another objective of the present disclosure is to provide a manufacturing method of a high-capacity battery cell, which can effectively join an integrated tab portion of one high-capacity battery cell through a plurality of unit electrode assemblies.

In order to achieve the above objectives, according to one aspect of the present disclosure, there is provided a high-capacity battery cell, including: a unit assembly in which a plurality of unit electrode assemblies are stacked. A plurality of individual tab portions of the plurality of unit electrode assemblies may be integrally joined together and joined to an integrated tab portion at one or each of opposite ends of the unit assembly.

Here, the high-capacity battery cell may further include an individual welding portion in which the plurality of individual tab portions of the plurality of unit electrode assemblies are welded and joined together in a region other than a first region in which a bundle of a plurality of foils of each of the unit electrode assemblies is integrally welded together; and an integrated welding portion in which the individual welding portion is welded and joined to one integrated tab portion. The individual welding portion and the integrated welding portion may be formed in pattern shapes that do not overlap with each other in a second region, which is one welding region.

In addition, the high-capacity battery cell may further include: an individual welding portion in which the plurality of individual tab portions of the plurality of unit electrode assemblies are welded and joined together; and an integrated welding portion in which the individual welding portion is welded and joined to one integrated tab portion. The individual welding portion and the integrated welding portion may form welding regions of patterns that do not overlap with each other in the second region.

In addition, the individual welding portion may be formed along each of opposite ends of the second region and may be formed such that concave and convex portions are alternately arranged inwardly to form an inner space, and the integrated welding portion may be formed in a complementary shape that does not overlap with the individual welding portion in the inner space of the second region.

According to another aspect of the present disclosure, there is provided a manufacturing method of a high-capacity battery cell, the manufacturing method including: forming an individual tab portion by welding a first region of one end of a bundle of a plurality of foils of a unit electrode assembly; stacking a plurality of unit electrode assemblies and welding a plurality of individual tab portions at an individual welding portion of a second region; cutting a first region except for the second region; and welding and joining the plurality of individual tab portions and an integrated tab portion at an integrated welding portion except for the individual welding portion of the second region.

Here, the first region and the second region may be formed as different regions, and the second region may include the individual welding portion in which the plurality of individual tab portions are welded and the integrated welding portion in which the individual welding portion is welded to the integrated tab portion. The individual welding portion and the integrated welding portion may be formed within a predetermined range so as not to overlap with each other in the second region.

In addition, the individual welding portion of the second region may be formed such that concave and convex portions are alternately arranged inwardly along a longitudinal direction of each of opposite ends of the second region, and the integrated welding portion may be formed in a complementary shape in an unwelded inner space between the respective individual welding portions.

In addition, the welding of the first region may be performed in the entire area of the first region, and the second region may have an outer area in which the individual welding portion is formed and an inner area that does not overlap with the outer area and in which the integrated welding portion is formed.

In addition, the forming of the individual tab portion by welding the first region of the one end of the bundle of the plurality of foils of the unit electrode assembly may further include: coupling a film to cover an outside of the unit electrode assembly and curing the film.

In addition, the stacking of the plurality of unit electrode assemblies and the welding of the plurality of individual tab portions at the individual welding portion of the second region may further include: bonding the stacked plurality of electrode assemblies with an adhesive.

The features and advantages of the present disclosure will be more clearly understood from the following detailed description when taken in conjunction with the accompanying drawings.

All terms or words used in the specification and claims have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

According to the present disclosure, by manufacturing one high-capacity battery cell by stacking and bonding a plurality of unit electrode assemblies, it is possible to implement a high-capacity battery cell of various specifications, thereby effectively expanding the degree of freedom in designing the thickness of a pouch-type battery cell.

In addition, by preventing welding for joining an integrated tab portion from being performed in an overlapping manner in the same region when stacking and bonding a plurality of unit electrode assemblies, it is possible to effectively secure the electrical reliability and operating performance of joining of the integrated tab portion.

In addition, by supplementing the structure of an electrode assembly and a manufacturing method thereof to ensure the strength and stability of coupling between the unit electrode assemblies when they are stacked and bonded, it is possible to secure the structural stability of the high-capacity battery cell.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view illustrating a high-capacity battery cell according to an embodiment of the present disclosure;

FIG. 2A and FIG. 2B are schematic partial plan and side views illustrating a step of welding a foil bundle of a unit electrode assembly according to a manufacturing method of a high-capacity battery cell according to an embodiment of the present disclosure;

FIGS. 3A and 3B are schematic partial plan and side views illustrating a step of welding individual tab portions of a plurality of unit electrode assemblies according to the manufacturing method of the high-capacity battery cell according to the embodiment of the present disclosure;

FIGS. 4A and 4B are schematic partial plan and side views illustrating a step of partially cutting the individual tab portions of the plurality of unit electrode assemblies according to the manufacturing method of the high-capacity battery cell according to the embodiment of the present disclosure;

FIG. 5 is a plan view illustrating the individual tab portions of the plurality of unit electrode assemblies according to the manufacturing method of the high-capacity battery cell according to the embodiment of the present disclosure; and

FIGS. 6A and 6B are schematic partial plan and side views illustrating a step of welding the individual tab portions and integrated tab portions of the plurality of unit electrode assemblies according to the manufacturing method of the high-capacity battery cell according to the embodiment of the present disclosure.

### DETAILED DESCRIPTION OF THE INVENTION

As for reference numerals associated with elements in the drawings, the same reference numerals are used throughout the different drawings to designate the same or similar elements.

The terminology used herein is for the purpose of describing particular embodiments only and is not intended to be limiting. As used herein, the singular forms are intended to include the plural forms as well, unless the context clearly indicates otherwise.

The drawings may be schematic or exaggerated to illustrate embodiments. In this document, expressions “have”, “may have”, “includes”, or “may include” specify the presence of stated features (e.g., a numerical value, function, operation, or element such as a part), but do not preclude the presence of additional features.

Terms such as “one”, “other”, “another”, “first”, and “second”, etc. are used only to distinguish one element from another element, these elements should not be limited by these terms.

Hereinbelow, exemplary embodiments of the present disclosure will be described in detail with reference to the accompanying drawings.

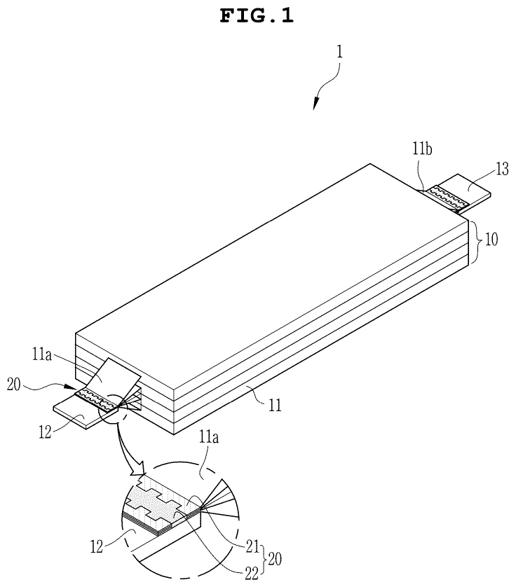

FIG. 1 is a perspective view illustrating a high-capacity battery cell according to an embodiment of the present disclosure.

The high-capacity battery cell according to the embodiment of the present disclosure includes a unit assembly 10 in which a plurality of unit electrode assemblies 11 are stacked. A plurality of individual tab portions 11a, 11b of the plurality of unit electrode assemblies 11 are integrally joined together and joined to an integrated tab portion 12, 13 at one or each of opposite ends of the unit assembly 10.

In the embodiment of the present disclosure, a unit electrode assembly 11 may refer to one electrode assembly in which a positive electrode plate, a negative electrode plate, and a separator provided for insulation between the positive electrode plate and the negative electrode plate are manufactured in a jelly-roll shape. However, the shape of the electrode assembly is not limited to the jelly-roll shape and may include shapes formed by various stacking methods.

As illustrated in FIG. 1, the high-capacity battery cell according to the embodiment of the present disclosure may be formed by stacking the plurality of unit electrode assemblies 11. Each of the plurality of unit electrode assemblies 11 may be configured such that a plurality of foils are welded to form a positive electrode tab for electrical connection of a positive terminal or a negative electrode tab for electrical connection of a negative terminal. Therefore, an individual tab portion 11a, 11b of the unit electrode assembly 11 may be formed as a negative electrode tab or a positive electrode tab by welding and joining together the plurality of foils.

That is, a bundle of a plurality of foils may be integrally welded and joined together in a first region 11c to form the individual tab portion 11a, 11b of the unit electrode assembly 11. An individual welding portion 21 for integrally welding and joining together the plurality of individual tab portions 11a, 11b of the plurality of stacked unit electrode assemblies 11 may be formed in a second region 20, which is a non-overlapping region other than the first region 11c. That is, the bundle of the plurality of foils of the unit electrode assembly 11 may be welded in the first region 11c to form the individual tab portion 11a, 11b, and the plurality of individual tab portions 11a, 11b may be welded and joined together through the individual welding portion 21 in the second region 20 other than the first region 11c.

As illustrated in FIG. 1, the integrated tab portions 12 and 13 including positive and negative electrodes may each be welded and joined again in the second region 20 in which the plurality of individual tab portions 11a, 11b of the plurality of unit electrode assemblies 11 are welded and joined together, thereby forming the high-capacity battery cell composed of the unit assembly 10.

The second region 20 may include the individual welding portion 21 in which the plurality of individual tab portions 11a, 11b of the plurality of unit electrode assemblies 11 are welded and an integrated welding portion 22 in which the welded individual tab portions 11a, 11b are welded again to one integrated tab portion 12, 13. However, in the second region 20, the individual welding portion 21 and the integrated welding portion 22 may be formed to occupy a space without overlapping with each other. That is, it is possible to avoid performing overlapping welding processing in the same region.

As illustrated in the partially enlarged view of FIG. 1, the individual welding portion 21 of the high-capacity battery cell according to the embodiment of the present disclosure may be formed longitudinally along each of opposite ends of the second region 20, and may be formed in a pattern in which concave and convex portions are alternately formed inwardly. Then, when welding and joining the welded individual tab portions 11a, 11b to the one integrated tab portion 12, 13, the welded individual tab portions 11a, 11b and the one integrated tab portion 12, 13 may be welded and joined together by using the remaining region where the individual welding portion 21 of the second region 20 is not formed.

That is, when the individual tab portions 11a, 11b of the plurality of unit electrode assemblies 11 are welded and joined together and then the one integrated tab portion 12, 13 is welded and joined thereto again, it is possible to overcome spatial constraints for joining and effectively secure the reliability of welding.

The pattern shape of the second region 20 illustrated in FIG. 1 is only an example. The individual welding portion 21 where the plurality of individual tab portions 11a, 11b of the plurality of unit electrode assemblies 11 are welded and joined together and the integrated welding portion 22 where the welded individual tab portions 11a, 11b and the integrated tab portion 12, 13 are welded and joined together may be formed at an appropriate ratio by considering the joining force or the area required for joining in each region.

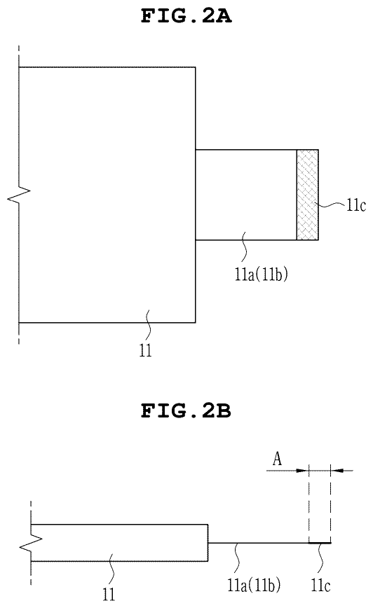

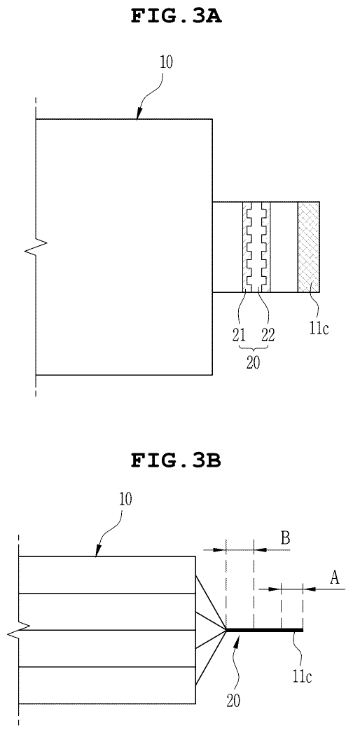

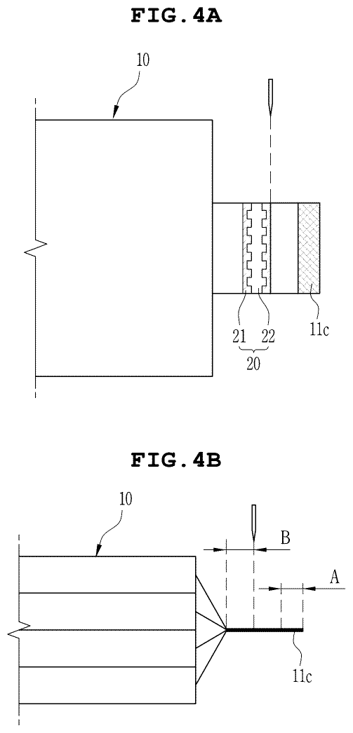

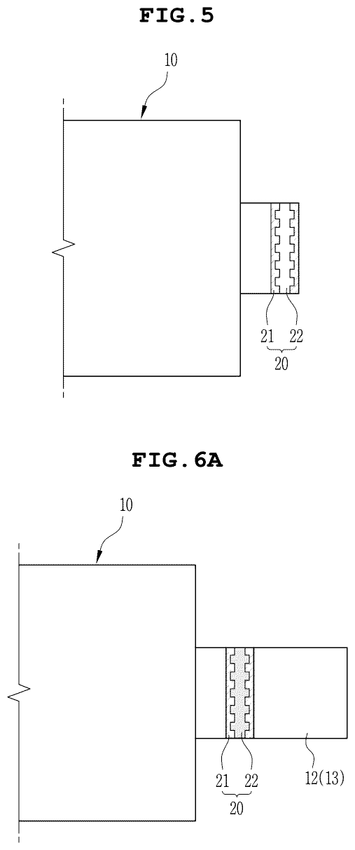

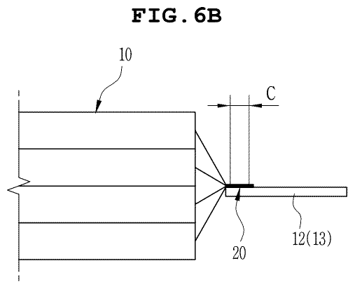

FIG. 2A and FIG. 2B are schematic partial plan and side views illustrating a step of welding a foil bundle of a unit electrode assembly according to a manufacturing method of a high-capacity battery cell according to an embodiment of the present disclosure. FIGS. 3A and 3B are schematic partial plan and side views illustrating a step of welding individual tab portions of a plurality of unit electrode assemblies according to the manufacturing method of the high-capacity battery cell according to the embodiment of the present disclosure. FIGS. 4A and 4B are schematic partial plan and side views illustrating a step of partially cutting the individual tab portions of the plurality of unit electrode assemblies according to the manufacturing method of the high-capacity battery cell according to the embodiment of the present disclosure. FIG. 5 is a plan view illustrating the individual tab portions of the plurality of unit electrode assemblies according to the manufacturing method of the high-capacity battery cell according to the embodiment of the present disclosure. FIGS. 6A and 6B are schematic partial plan and side views illustrating a step of welding the individual tab portions and integrated tab portions of the plurality of unit electrode assemblies according to the manufacturing method of the high-capacity battery cell according to the embodiment of the present disclosure.

The manufacturing method of the high-capacity battery cell according to the embodiment of the present disclosure includes: forming an individual tab portion 11a, 11b by welding a first region 11c of one end of a bundle of a plurality of foils of a unit electrode assembly 11; stacking a plurality of unit electrode assemblies 11 and welding a plurality of individual tab portions 11a, 11b at an individual welding portion 21 of a second region 20; cutting the first region 11c except for the second region 20; and welding the plurality of individual tab portions 11a, 11b and an integrated tab portion 12, 13 at an integrated welding portion 22 except for the individual welding portion 21 of the second region 20.

First, the individual tab portion 11a, 11b is formed by welding the first region 11c of the one end of the bundle of the plurality of foils of the unit electrode assembly 11. Here, the bundle of the plurality of foils of the unit electrode assembly 11 is not illustrated, but this is a step of welding the bundle of the plurality of foils (metal) to form positive and negative electrode plates of the unit electrode assembly 11 into electrode tabs.

As illustrated in FIGS. 2A and 2B, the individual tab portion 11a, 11b is formed by welding the first region 11c of the bundle of the plurality of foils of the unit electrode assembly 11. As described above in the embodiment of the high-capacity battery cell according to the present disclosure, the unit electrode assembly 11 is exemplified as a jelly-roll shape in which a positive electrode plate, a negative electrode plate, and a separator formed between the positive and negative electrode plates are provided. However, it is understood that the present disclosure includes various types of electrode assemblies depending on the stacking shape.

The bundle of the plurality of foils on one side where a positive or negative electrode tab of the unit electrode assembly 11 is to be formed is welded in the first region 11c. The first region 11c may be formed at one end of the individual tab portion 11a, 11b of the unit electrode assembly 11. This is to secure the second region 20 for welding the plurality of individual tab portions 11a, 11b and welding the plurality of individual tab portions 11a, 11b and one integrated tab portion 12, 13 after the plurality of unit electrode assemblies 11 are stacked.

The position of the first region 11c is not particularly limited to the one end, but may be appropriately selected for the region for welding the plurality of individual tab portions 11a, 11b welded to the integrated tab portion 12, 13 of the high-capacity battery cell, which will be described later.

As illustrated in FIG. 2B, the bundle of the plurality of foils of the unit electrode assembly 11 is welded in the first region 11c of an appropriate width A to form the individual tab portion 11a, 11b.

Next, the plurality of unit electrode assemblies 11 are stacked, and the plurality of individual tab portions 11a, 11b of the plurality of stacked unit electrode assemblies 11 are then welded together. After forming one unit assembly 10 by stacking the plurality of unit electrode assemblies 11, the plurality of individual tab portions 11a, 11b of the plurality of unit electrode assemblies 11 may be joined by welding to be joined to the one integrated tab portion 12, 13.

In the case of stacking the plurality of unit electrode assemblies 11, in order to maintain the stacking alignment or strength between the plurality of unit electrode assemblies 11, the present disclosure may further include covering the outside of each of the plurality of unit electrode assemblies 11 with a predetermined film during manufacturing and then curing and fixing the film.

In addition, the plurality of unit electrode assemblies 11 may be stacked through bonding to enhance the stability or fixing force of coupling between the plurality of unit electrode assemblies 11.

As illustrated in FIGS. 3A and 3B, the plurality of individual tab portions 11a, 11b may be welded and joined together through the individual welding portion 21 with a predetermined width B in the second region 20 excluding the first region 11c of the individual tab portions 11a, 11b. Here, a welding method is used as an example, but various types of known joining methods for joining the plurality of individual tab portions 11a, 11b may be applied.

The welding of the plurality of individual tab portions 11a, 11b may be performed in a partial area of the second region 20. When welding and joining the plurality of individual tab portions 11a, 11b and the one integrated tab portion 12, 13 simultaneously, it may be difficult to secure the reliability of the joining force depending on the number of plurality of unit electrode assemblies 11. For this reason, the plurality of individual tab portions 11a, 11b may be primarily welded and joined together.

Here, the plurality of individual tab portions 11a, 11b may be welded at the individual welding portion 21 that leaves a predetermined area for welding the integrated tab portion 12, 13 in the second region 20. In this case, considering the reliability of the joining of the plurality of individual tab portions 11a, 11b, it is appropriate to form the individual welding portion 21 in a continuous shape in the width direction of the individual tab portions 11a, 11b.

In addition, concave and convex portions may be alternately formed inwardly while forming a predetermined inner space of the second region 20 to improve the joining force between the plurality of individual tab portions 11a, 11b.

Next, the first region 11c in which the bundle of the plurality of foils of the unit electrode assembly 11 is welded is cut at the individual tab portion 11a, 11b. Here, the first region 11c may be cut without overlapping with the second region 20 to allow the integrated tab portion 12, 13 to be welded subsequently in the second region 20.

The first region 11c serves to fix the plurality of individual tab portions 11a, 11b so as to be welded, thereby increasing the reliability of alignment, etc. of subsequent welding of the plurality of individual tab portions 11a, 11b. By cutting the first region 11c, constraints on a joining length of the integrated tab portion 12, 13 in the high-capacity battery cell or a space required for installing the high-capacity battery cell may be eliminated, thereby substantially improving the degree of design freedom when installing the high-capacity battery cell.

As illustrated in FIGS. 4A and 4B, the first region 11c may be cut and removed with respect to one side boundary of the second region 20 in which the plurality of individual tab portions 11a, 11b are welded. By this process, an unnecessary welding region resulting when joining the one integrated tab portion 12, 13 may be reduced. Also, by joining the integrated tab portion 12, 13 in a predetermined space in the second region 20, the overall protruding length of the integrated tab portion 12, 13 may be effectively controlled.

Next, as illustrated in FIG. 5, the integrated tab portion 12, 13 may be welded and joined at the integrated welding portion 22, which is the remaining space of the second region 20 in which the plurality of individual tab portions 11a, 11b are welded.

The individual welding portion 21 and the integrated welding portion 22 of the second region 20 may have a complementary pattern, and may be welded and joined in a form that completely fills the second region 20. The shape of the pattern occupied by the individual welding portion 21 and the integrated welding portion 22 of the second region 20 may be appropriately modified and changed to secure the minimum welding region required depending on the thickness or material of the plurality of individual tab portions 11a, 11b.

Alternatively, although not illustrated, both the individual welding portion 21 and the integrated welding portion 22 may be formed on a first surface of the plurality of individual tab portions 11a, 11b to match the pattern of the individual welding portion 21 and the integrated welding portion 22 of the second region 20, or the individual welding portion 21 may be formed on the first surface of the plurality of individual tab portions 11a, 11b and the integrated welding portion 22 may be formed on a second surface of the plurality of individual tab portions 11a, 11b so that welding is performed through the individual welding portion 21 and the integrated welding portion 22.

As illustrated in FIGS. 6A and 6B, the plurality of individual tab portions 11a, 11b may be welded and joined together through the individual welding portion 21 of the second region 20, and the plurality of individual tab portions 11a, 11b and the one integrated tab portion 12, 13 may be welded and joined together again through the integrated welding portion 22 that does not overlap with the individual welding portion 21 of the second region 20.

That is, the individual welding portion 21 may be formed to extend in the longitudinal direction at each of opposite ends of the second region 20, and the integrated welding portion 22 may be formed in the remaining inner space between the respective individual welding portions 21 of the second region 20 so that the plurality of individual tab portions 11a, 11b and the integrated tab portion 12, 13 to be welded and joined through the integrated welding portion 22.

As described above, by primarily welding and joining the plurality of individual tab portions 11a, 11b at the individual welding portion 21 of the second region 20 and secondarily welding and joining the integrated tab portion 12, 13 at the integrated welding portion 22 that does not overlap with the region for primary welding, it is possible to simultaneously secure the tension and safety of the integrated tab portion 12, 13 connected to the plurality of individual tab portions 11a, 11b.

The present disclosure has been described in detail through specific embodiments. The embodiments are provided to specifically describe the present disclosure, but the present disclosure is not limited thereto. It will be apparent to those skilled in the art that the present disclosure can be modified or changed in various forms without departing from the technical spirit of the present disclosure.

Simple modifications or changes of the present disclosure belong to the scope of the present disclosure, and the detailed scope of the present disclosure will be more clearly understood by the accompanying claims.

What is claimed is:

1. A high-capacity battery cell, comprising:
a unit assembly in which a plurality of unit electrode assemblies are stacked,
wherein a plurality of individual tab portions of the plurality of unit electrode assemblies are integrally joined together and joined to an integrated tab portion at one or each of opposite ends of the unit assembly.

2. The high-capacity battery cell of claim 1, further comprising:
an individual welding portion in which the plurality of individual tab portions of the plurality of unit electrode assemblies are welded and joined together in a region other than a first region in which a bundle of a plurality of foils of each of the unit electrode assemblies is integrally welded together, and
an integrated welding portion in which the individual welding portion is welded and joined to one integrated tab portion,
wherein the individual welding portion and the integrated welding portion are formed in pattern shapes that do not overlap with each other in a second region, which is one welding region.

3. The high-capacity battery cell of claim 1, further comprising:
an individual welding portion in which the plurality of individual tab portions of the plurality of unit electrode assemblies are welded and joined together; and
an integrated welding portion in which the individual welding portion is welded and joined to one integrated tab portion,
wherein the individual welding portion and the integrated welding portion form welding regions of patterns that do not overlap with each other in the second region.

4. The high-capacity battery cell of claim 3, wherein the individual welding portion is formed along each of opposite ends of the second region and is formed such that concave and convex portions are alternately arranged inwardly to form an inner space, and
the integrated welding portion is formed in a complementary shape that does not overlap with the individual welding portion in the inner space of the second region.

5. A manufacturing method of a high-capacity battery cell, the manufacturing method comprising:
forming an individual tab portion by welding a first region of one end of a bundle of a plurality of foils of a unit electrode assembly;
stacking a plurality of unit electrode assemblies and welding a plurality of individual tab portions at an individual welding portion of a second region;
cutting a first region except for the second region; and
welding and joining the plurality of individual tab portions and an integrated tab portion at an integrated welding portion except for the individual welding portion of the second region.

6. The manufacturing method of claim 5, wherein the first region and the second region are formed as different regions, and
the second region includes the individual welding portion in which the plurality of individual tab portions are welded and the integrated welding portion in which the individual welding portion is welded to the integrated tab portion,
wherein the individual welding portion and the integrated welding portion are formed within a predetermined range so as not to overlap with each other in the second region.

7. The manufacturing method of claim 6, wherein the individual welding portion of the second region is formed such that concave and convex portions are alternately arranged inwardly along a longitudinal direction of each of opposite ends of the second region, and
the integrated welding portion is formed in a complementary shape in an unwelded inner space between the respective individual welding portions.

8. The manufacturing method of claim 5, wherein the welding of the first region is performed in the entire area of the first region, and
the second region has an outer area in which the individual welding portion is formed and an inner area that does not overlap with the outer area and in which the integrated welding portion is formed.

9. The manufacturing method of claim 5, wherein the forming of the individual tab portion by welding the first region of the one end of the bundle of the plurality of foils of the unit electrode assembly further comprises:
coupling a film to cover an outside of the unit electrode assembly and curing the film.

10. The manufacturing method of claim 5, wherein the stacking of the plurality of unit electrode assemblies and the welding of the plurality of individual tab portions at the individual welding portion of the second region further comprises:
bonding the stacked plurality of electrode assemblies with an adhesive.
